(19) United States
(12) Patent Application Publication
(10) Pub. No.: US 2021/0150422 A1
(43) Pub. Date: May 20, 2021

(54) MANAGEMENT DEVICE, MANAGEMENT SYSTEM, AND MANAGEMENT METHOD FOR AUTOMATED VALET PARKING

(71) Applicant: Toyota Jidosha Kabushiki Kaisha, Toyota-shi Aichi-ken (JP)

(72) Inventor: Miyuki Takato, Toyota-shi (JP)

(73) Assignee: Toyota Jidosha Kabushiki Kaisha, Toyota-shi Aichi-ken (JP)

(21) Appl. No.: 17/082,403

(22) Filed: Oct. 28, 2020

(30) Foreign Application Priority Data
Nov. 20, 2019 (JP) 2019-209893

(51) Int. Cl. G06Q 10/02; G08G 1/14; G06Q 10/06; G06Q 30/02; G06Q 30/00; G07C 9/38

(52) U.S. Cl. CPC G06Q 10/02; G08G 1/141; G06Q 10/06315; G06Q 30/0201; G05D 1/0088; G06Q 30/016; G07C 9/38; G06Q 2240/00; G05D 2201/0213; G06Q 30/0284

(57) ABSTRACT

The management device includes: a reception unit configured to receive facility usage information including a scheduled time of entry or exit of the vehicle by automated valet parking; an acquisition unit configured to acquire facility management information indicating a congestion status of a parking facility at the scheduled time of entry or exit based on the facility usage information; a generation unit configured to generate boarding and alighting area candidate information in which usage incentive information corresponding to the congestion status is provided for each of candidates of the boarding and alighting areas, based on the facility management information; and a transmission unit configured to transmit the boarding and alighting area candidate information to the terminal device associated with the vehicle.

### CROSS-REFERENCE TO RELATED APPLICATIONS

This application claims priority to Japanese Patent Application No. 2019-209893 filed on Nov. 20, 2019, incorporated herein by reference in its entirety.

### BACKGROUND

### 1. Technical Field

The disclosure relates to a management device, a management system, and a management method for automated valet parking.

### 2. Description of Related Art

Japanese Unexamined Patent Application Publication No. 2019-66932 (JP 2019-66932 A) discloses a technique related to a management device for carrying out the exit of a vehicle from a parking lot by causing the vehicle to travel by itself. In this technique, the management device acquires the position of the user, estimates the time at which the user arrives at a position to ride on the vehicle, and adjusts the exit time of the vehicle in consideration of the estimated arrival time.

### SUMMARY

The parking facility used in the automated valet parking service has limited space. For this reason, in the case where the time ranges of entry or exit of a plurality of vehicles overlap, the boarding and alighting area may be crowded to make smooth entry or exit difficult, even if the arrival times of the users are predicted. It is conceivable to provide a plurality of boarding and alighting areas as countermeasures. In this case, however, it is necessary to devise a way to restrain vehicles from concentrating on a particular boarding and alighting area.

The disclosure provides a management device, a management system, and a management method for automated valet parking that can guide, in a parking facility offering an automated valet parking service and having a plurality of boarding and alighting areas, a user to a recommended boarding and alighting area depending on a congestion status of the parking facility.

A first aspect of the disclosure relates to a management device. The management device is configured to manage automated valet parking in which, in a parking facility having a plurality of boarding and alighting areas, entry of a vehicle from a used boarding and alighting area selected from the boarding and alighting areas to a parking space of the parking facility or exit of the vehicle from the parking space to the used boarding and alighting area is performed through autonomous traveling of the vehicle. The management device includes: a reception unit configured to receive facility usage information including a scheduled time of entry or exit of the vehicle by the automated valet parking; an acquisition unit configured to acquire facility management information indicating a congestion status of the parking facility at the scheduled time of entry or exit, based on the facility usage information; a generation unit configured to generate boarding and alighting area candidate information in which usage incentive information corresponding to the congestion status is provided for each of candidates of the boarding and alighting areas, based on the facility management information; and a transmission unit configured to transmit the boarding and alighting area candidate information to a terminal device associated with the vehicle.

In the first aspect, the facility management information may be information indicating a degree of congestion of each of the boarding and alighting areas at the scheduled time of entry or exit. The generation unit may be configured to provide more favorable usage incentive information for a second boarding and alighting area than for a first boarding and alighting area, the second boarding and alighting area having a lower degree of congestion than the first boarding and alighting area.

According to the above configuration, more favorable usage incentive information is provided for the second boarding and alighting area than for the first boarding and alighting area, the second boarding and alighting area having a lower degree of congestion than the first boarding and alighting area. This makes it possible to guide users to the boarding and alighting area having a lower degree of congestion.

In the first aspect, the parking facility may include a plurality of parking areas respectively corresponding to the boarding and alighting areas. The facility management information may be information regarding a distribution of parked vehicles in each of the parking areas at the scheduled time of entry or exit. The generation unit may be configured to provide more favorable usage incentive information for a second boarding and alighting area corresponding to a second parking area than for a first boarding and alighting area corresponding to a first parking area, the second parking area having a lower distribution of parked vehicles than the first parking area.

According to the above configuration, more favorable usage incentive information is provided for the second boarding and alighting area corresponding to the second parking area than for the first boarding and alighting area corresponding to the first parking area, the second parking area having a lower distribution of parked vehicles than the first parking area. This makes it possible to guide the users to the boarding and alighting area corresponding to the parking area having a lower degree of congestion.

In the first aspect, the parking facility may include a commercial facility attached to the parking facility. The facility management information may be information regarding a distribution of people in the commercial facility at the scheduled time of entry or exit. The generation unit may be configured to provide more favorable usage incentive information for a second boarding and alighting area corresponding to a second area than for a first boarding and alighting area corresponding to a first area, the second area having a lower distribution of people than the first area.

According to the above configuration, more favorable usage incentive information is provided for the second boarding and alighting area corresponding to the second area than for the first boarding and alighting area corresponding to the first area, the second area having a lower distribution of people than the first area. This makes it possible to guide the users to the boarding and alighting area corresponding to the area having a lower distribution of people in the commercial facility.

In the first aspect, the usage incentive information may include a proposal of reducing a usage fee related to the automated valet parking.

According to the above configuration, the usage incentive information includes a proposal of reducing the usage fee related to the automated valet parking. This makes it possible to guide the users to the boarding and alighting area for which the usage incentive offering a greater financial benefit is provided.

A second aspect of the disclosure relates to a management system for automated valet parking. The management system includes: a management device configured to manage automated valet parking in which, in a parking facility having a plurality of boarding and alighting areas, entry of a vehicle from a used boarding and alighting area selected from the boarding and alighting areas to a parking space of the parking facility or exit of the vehicle from the parking space to the used boarding and alighting area is performed through autonomous traveling of the vehicle; and a terminal device associated with the vehicle configured to perform the automated valet parking. The terminal device includes an input device and a display device. The terminal device is configured to input, through the input device, facility usage information including a scheduled time of entry or exit of the vehicle by the automated valet parking, and configured to transmit the facility usage information to the management device. The management device includes: a reception unit configured to receive the facility usage information; an acquisition unit configured to acquire facility management information indicating a congestion status of the parking facility at the scheduled time of entry or exit, based on the facility usage information; a generation unit configured to generate boarding and alighting area candidate information in which usage incentive information corresponding to the congestion status is provided for each of candidates of the boarding and alighting areas, based on the facility management information; and a transmission unit configured to transmit the boarding and alighting area candidate information to the terminal device associated with the vehicle. The terminal device is configured to display the received boarding and alighting area candidate information on the display device.

In the second aspect, the facility management information may be information indicating a degree of congestion of each of the boarding and alighting areas at the scheduled time of entry or exit. The generation unit may be configured to provide more favorable usage incentive information for a second boarding and alighting area than for a first boarding and alighting area, the second boarding and alighting area having a lower degree of congestion than the first boarding and alighting area.

According to the above configuration, more favorable usage incentive information is provided for the second boarding and alighting area than for the first boarding and alighting area, the second boarding and alighting area having a lower degree of congestion than the first boarding and alighting area. This makes it possible to guide users to the boarding and alighting area having a lower degree of congestion.

In the second aspect, the parking facility may include a plurality of parking areas respectively corresponding to the boarding and alighting areas. The facility management information may be information regarding a distribution of parked vehicles in each of the parking areas at the scheduled time of entry or exit. The generation unit may be configured to provide more favorable usage incentive information for a second boarding and alighting area corresponding to a second parking area than for a first boarding and alighting area corresponding to a first parking area, the second parking area having a lower distribution of parked vehicles than the first parking area.

According to the above configuration, more favorable usage incentive information is provided for the second boarding and alighting area corresponding to the second parking area than for the first boarding and alighting area corresponding to the first parking area, the second parking area having a lower distribution of parked vehicles than the first parking area. This makes it possible to guide the users to the boarding and alighting area having a lower degree of congestion.

In the second aspect, the parking facility may include a commercial facility attached to the parking facility. The facility management information may be information regarding a distribution of people in the commercial facility at the scheduled time of entry or exit. The generation unit may be configured to provide more favorable usage incentive information for a second boarding and alighting area corresponding to a second area than for a first boarding and alighting area corresponding to a first area, the second area having a lower distribution of people than the first area.

According to the above configuration, more favorable usage incentive information is provided for the second boarding and alighting area corresponding to the second area than for the first boarding and alighting area corresponding to the first area, the second area having a lower distribution of people than the first area. This makes it possible to guide the users to the boarding and alighting area corresponding to the area having a lower distribution of people in the commercial facility.

In the second aspect, the usage incentive information may include a proposal of reducing a usage fee related to the automated valet parking.

According to the above configuration, the usage incentive information includes a proposal of reducing the usage fee related to the automated valet parking. This makes it possible to guide the users to the boarding and alighting area for which the usage incentive offering a greater financial benefit is provided.

A third aspect of the disclosure relates to a method for managing automated valet parking. In the automated valet parking, in a parking facility having a plurality of boarding and alighting areas, entry of a vehicle from a used boarding and alighting area selected from the boarding and alighting areas to a parking space of the parking facility or exit of the vehicle from the parking space to the used boarding and alighting area is performed through autonomous traveling of the vehicle. The method includes: a reception step of receiving facility usage information including a scheduled time of entry or exit of the vehicle by the automated valet parking; an acquisition step of acquiring facility management information indicating a congestion status of the parking facility at the scheduled time of entry or exit, based on the facility usage information; a generation step of generating boarding and alighting area candidate information in which usage incentive information corresponding to the congestion status is provided for each of candidates of the boarding and alighting areas, based on the facility management information; and a display step of displaying the boarding and alighting area candidate information on a display device of a terminal device associated with the vehicle.

According to the first aspect, the second aspect, and the third aspect of the disclosure, the boarding and alighting area candidate information including the information of the candidates of the boarding and alighting areas is transmitted to the terminal device associated with the vehicle. In the boarding and alighting area candidate information, the usage incentive information corresponding to the congestion status of the parking facility at the scheduled time of entry or exit is provided for information of each candidate of the boarding and alighting areas. Thus, according to the first aspect, the second aspect, and the third aspect of the disclosure, it is possible to guide the users to the boarding and alighting area having a lower degree of congestion based on content of the provided usage incentive information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a management system for automated valet parking;

FIG. 2 is a diagram illustrating an outline of a parking facility managed by the management system according to a first embodiment;

FIG. 3 is a functional block diagram illustrating functions of the management device;

FIG. 4 is a flowchart illustrating a flow of an automated valet parking service provided by the management system;

FIG. 5 is a diagram showing an example of boarding and alighting area candidate information displayed on a user terminal;

FIG. 6 is a schematic diagram illustrating another example of the parking facility managed by the management system according to the first embodiment; and

FIG. 7 is a diagram schematically showing a distribution of people in a commercial facility.

### DETAILED DESCRIPTION OF EMBODIMENTS

Hereinafter, embodiments of the disclosure will be described with reference to the drawings. However, in the following embodiments, when numbers of each element, such as the number, the quantity, the amount, the range, etc. thereof, are mentioned, the disclosure is not limited by the numbers mentioned unless explicitly stated or clearly specified in theory. Further, structures, steps, and the like described in the following embodiments are not necessarily essential to the disclosure, unless explicitly stated or clearly specified in theory.

### First Embodiment

### 1-1. Management System for Automated Valet Parking

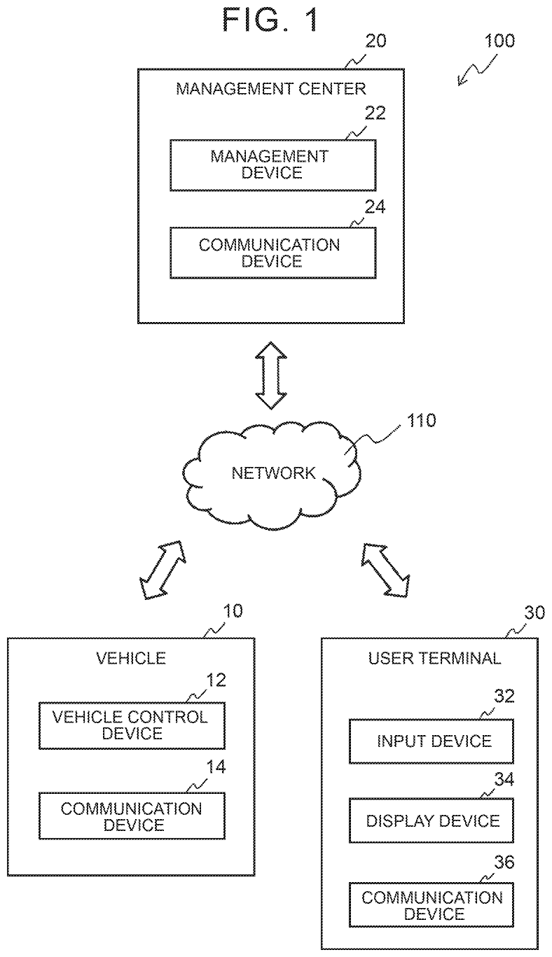

FIG. 1 is a block diagram illustrating a configuration of a management system for automated valet parking. A management system 100 according to the present embodiment is a system for managing an automated valet parking service that realizes movement on a travel route between a boarding and alighting area and a designated parking space by autonomous traveling of a vehicle. The management system 100 includes a vehicle 10, a management center 20, and a user terminal 30.

The vehicle 10 is an autonomous traveling vehicle capable of autonomously traveling based on various kinds of information, at least on a route between a boarding and alighting area and a designated parking space in parking facility that provides an automated valet parking service. The vehicle 10 includes a vehicle control device 12 and a communication device 14. The vehicle control device 12 is an electronic control unit (ECU) having at least one processor and one memory. The memory stores at least one program and various kinds of data for autonomous traveling. The program stored in the memory is read out and executed by the processor so that various functions for autonomous traveling are implemented in the vehicle control device 12. The vehicle control device 12 controls driving, steering, and braking of the vehicle so that the vehicle travels along the set travel route. There are various autonomous traveling methods, and in the embodiment of the disclosure, the autonomous traveling method itself is not limited. Therefore, the detailed description thereof will be omitted.

The vehicle control device 12 is configured to be connected to a network 110 using the communication device 14. The vehicle control device 12 is connected to the management center 20 for the parking facility via the network 110.

The management center 20 is, for example, a facility operated by a parking facility provider. The management center 20 includes a management device 22 and a communication device 24. The management device 22 is an electronic control unit (ECU) having at least one processor and one memory. The memory stores at least one program and various kinds of data for operating the parking facility. The program stored in the memory is read out and executed by the processor so that various functions for operating the parking facility are implemented in the management device 22. The functions implemented in the management device 22 will be described in detail later. The communication device 24 is configured to be connected to the vehicle control device 12 of the vehicle 10 or the user terminal 30 via the network 110.

The user terminal 30 is a terminal device carried by a user of the automated valet parking service. The user terminal 30 is associated with the vehicle 10 used by the user. The user terminal 30 includes at least an input device 32, a display device 34, and a communication device 36. The input device 32 is a device for the user to input various kinds of information such as reservation information for the automated valet parking service. The display device 34 is a device for displaying various kinds of information. Examples of the input device 32 and the display device 34 include a touch panel display. The user terminal 30 is configured as a wireless communication terminal that can be connected to a base station (not shown) of the network 110 using the communication device 36. Examples of the user terminal 30 include a smartphone. An application for using the automated valet parking service is installed in the user terminal 30. The user terminal 30 is configured to communicate with the management center 20 via the network 110 by starting the application.

### 1-2. Overview of Automated Valet Parking Service

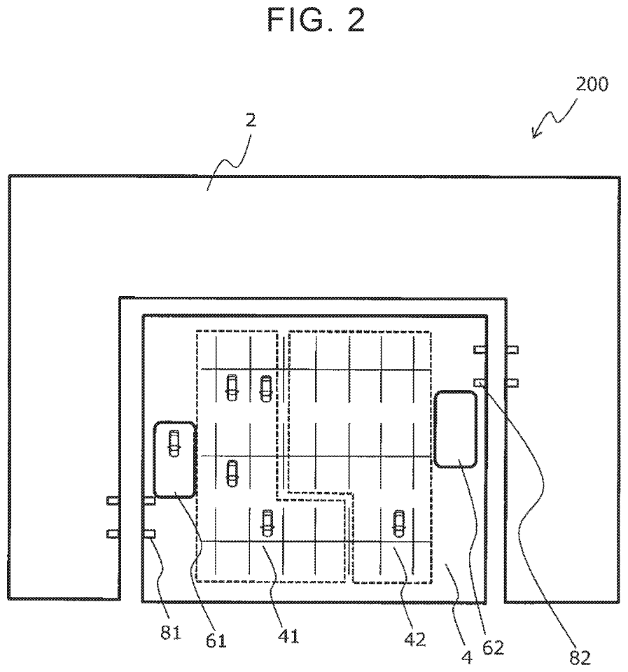

The management system 100 of the present embodiment is applied to a management system for parking a facility having a plurality of boarding and alighting areas. FIG. 2 is a diagram illustrating an outline of the parking facility managed by the management system according to the present embodiment. The parking facility 200 illustrated in FIG. 2 is a facility that provides the automated valet parking service executed by the management system of the present embodiment. The parking facility 200 includes a commercial facility 2 that is a building and a parking lot 4 for the commercial facility 2. The parking lot 4 is configured as a site having a rectangular shape in a plan view, and the commercial facility 2 is built so as to surround the parking lot 4 from the sides in a U-shape. The parking lot 4 is provided with a first boarding and alighting area 61 and a second boarding and alighting area 62 that serve as boarding and alighting areas for users of automated valet parking. In the following description, when there is no particular distinction between these boarding and alighting areas, they are simply referred to as “boarding and alighting areas 6”.

Near the first boarding and alighting area 61 and the second boarding and alighting area 62, a first entrance 81 and a second entrance 82 serving as entrances to the commercial facility 2 are provided, respectively. Parking areas of the parking lot 4 include a first parking area 41 for vehicles that use the first boarding and alighting area 61 and a second parking area 42 for vehicles that use the second boarding and alighting area 62. The first parking area 41 and the second parking area 42 may be configured as independent sections between which traffic of vehicles is restricted, or may be configured as a continuous parking area in which traffic of vehicles is not restricted.

In the parking facility 200 having the multiple boarding and alighting areas 6 as shown in FIG. 2, users may be dispersed to the multiple boarding and alighting areas 6 to reduce local congestion. However, the degree of congestion becomes uneven among the boarding and alighting areas 6, due to factors such as geographical characteristics and convenience of each boarding and alighting area 6. Thus, it is necessary to devise a way to actively guide users who normally use a boarding and alighting area having a high degree of congestion to a boarding and alighting area having a low degree of congestion.

Here, when using the automated valet parking service, each user inputs in advance facility usage information including at least a scheduled time of entry or exit of the vehicle 10 and transmits the scheduled time of entry or exit to the management device 22. Therefore, the management device 22 is able to know in advance the degree of congestion of each boarding and alighting area 6 at a specific time.

Thus, in the management system 100 according to the present embodiment, the management device 22 acquires information indicating the congestion status of the parking facility 200 at the user's scheduled time of entry or exit. In the following description, this information is referred to as “facility management information”. The facility management information includes, for example, a scheduled number of entering or exiting vehicles at each boarding and alighting area 6 at the scheduled time of entry or exit, a ratio of the scheduled number of entering or exiting vehicles to the number of available parking spaces associated with each boarding and alighting area 6 at the scheduled time of entry or exit, a distribution of parked vehicles in each parking area of the parking lot 4 at the scheduled time of entry or exit, and the like.

The management device 22 provides usage of a boarding and alighting area having a low degree of congestion (second boarding and alighting area 62 in FIG. 2), which is specified by the acquired facility management information, with a more favorable usage incentive than a usage incentive provided for usage of a boarding and alighting area having a high degree of congestion (first boarding and alighting area 61 in FIG. 2). The usage incentive here is an incentive provided to the usage of the applicable boarding and alighting area. Examples of the usage incentive include proposal of reducing the usage fee related to the automated valet parking service, or an offer of fee discount coupons for the next usage of the automated valet parking service, discount coupons and various points that can be used at stores in the commercial facility 2. The management device 22 transmits, to the user terminal 30, information in which the usage incentive information including the presence/absence of the usage incentive and content of the incentive is provided for each of candidates of the boarding and alighting areas 6. In the following description, this information is referred to as “boarding and alighting area candidate information”. The user refers to the usage incentive information included in the boarding and alighting area candidate information displayed on the display device 34, and selects, from the boarding and alighting areas 6, a used boarding and alighting area that the user desires to use.

With this operation, the user is likely to be guided to the usage of the boarding and alighting area having a low degree of congestion based on his/her desire for a more favorable usage incentive. As a result, it is possible to level the congestion of the boarding and alighting areas, which shortens the waiting time for the user and improves the occupancy rates of the parking facility.

Hereinafter, detailed configuration and operation of the automated valet parking service executed by the management system 100 will be described in more detail.

### 1-3. Specific Configuration Example of Management Device

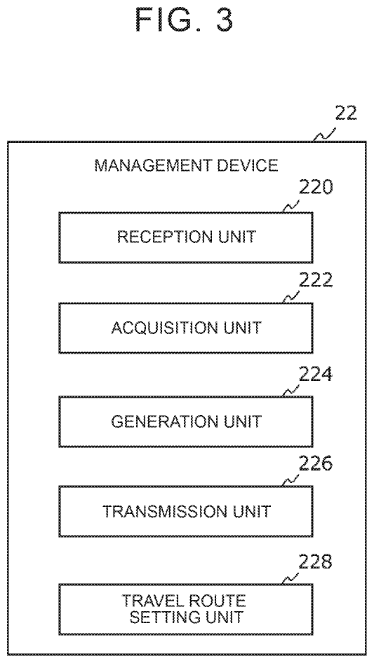

FIG. 3 is a functional block diagram illustrating the functions of the management device 22. As shown in FIG. 3, the management device 22 includes a reception unit 220, an acquisition unit 222, a generation unit 224, a transmission unit 226, and a travel route setting unit 228 as its functions.

The reception unit 220 receives the facility usage information of the vehicle 10 that uses the automated valet parking service. The facility usage information here includes the scheduled time of entry or exit of the vehicle 10 besides identification information of the vehicle 10. The received facility usage information is stored in the memory of the management device 22.

The acquisition unit 222 acquires the facility management information of the parking facility 200 at the scheduled time of entry or exit of the vehicle 10. Typically, the acquisition unit 222 acquires, as the facility management information, information indicating the degree of congestion of each boarding and alighting area 6 at the scheduled time of entry or exit. Examples of the facility management information include the ratio of the scheduled number of entering or exiting vehicles to the number of available parking spaces, the scheduled number of entering or exiting vehicles at each boarding and alighting area 6 at the scheduled time of entry or exit, and the like. Alternatively, the acquisition unit 222 acquires, as the facility management information, information regarding the distribution of parked vehicles in each parking area of the parking lot 4 at the scheduled time of entry or exit. Such facility management information includes the scheduled number of parked vehicles at the first parking area 41 and the second parking area 42 at the scheduled time of entry or exit, the ratio of the scheduled number of parked vehicles to the number of available parking spaces in each of the first parking area 41 and the second parking area 42 at the scheduled time of entry or exit, and the like. The acquired facility management information is stored in the memory of the management device 22.

The generation unit 224 generates the boarding and alighting area candidate information based on the facility management information. The management device 22 stores, in the memory, various usage incentives and basic information such as position information of the boarding and alighting areas 6. Based on the facility management information, the generation unit 224 generates the boarding and alighting area candidate information in which the usage incentive information is provided for information of each candidate of the boarding and alighting areas 6. Typically, when the facility management information is information indicating the degree of congestion of each boarding and alighting area 6 at the scheduled time of entry or exit, the generation unit 224 generates the boarding and alighting area candidate information such that the usage incentive provided for the second boarding and alighting area 62 having a low degree of congestion is more favorable than the usage incentive provided for the first boarding and alighting area 61 having a high degree of congestion. Alternatively, when the facility management information is information indicating the degree of congestion in each parking area of the parking lot 4 at the scheduled time of entry or exit, the generation unit 224 generates the boarding and alighting area candidate information such that the usage incentive provided for the second boarding and alighting area 62 corresponding to the second parking area 42 having a low degree of congestion is more favorable than the usage incentive provided for the first boarding and alighting area 61 corresponding to the first parking area 41 having a high degree of congestion.

Note that the more favorable usage incentive here indicates a usage incentive offering greater benefits for users, such as a higher rate of fee reduction and a larger number of points rewarded. In addition, in the boarding and alighting area candidate information, a plurality of candidates of the usage incentives that can be selected by the user may be provided for one boarding and alighting area. The generated boarding and alighting area candidate information is stored in the memory of the management device 22.

The transmission unit 226 reads out the boarding and alighting area candidate information stored in the memory and transmits the boarding and alighting area candidate information to the user terminal 30 associated with the vehicle 10.

The travel route setting unit 228 selects a parking space for the vehicle 10 and sets a travel route from the boarding and alighting area 6 to the parking space. There are various methods for selecting the parking space and setting the travel route. In the embodiment of the disclosure, the methods for selecting a parking space and setting a travel route themselves are not limited, and the detailed description thereof will be omitted.

In the management system 100 of the present embodiment, the reception unit 220 is an example of a “reception unit” of the disclosure, the acquisition unit 222 is an example of an “acquisition unit” of the disclosure, the generation unit 224 is an example of a “generation unit” of the disclosure, and the transmission unit 226 is an example of a “transmission unit” of the disclosure.

### 1-4. Specific Processes of Automated Valet Parking Service

The management system 100 provides the automated valet parking service for the vehicle 10 through transmission and reception of various kinds of information among the vehicle 10, the management center 20, and the user terminal 30 via the network 110. In the automated valet parking service, movement of the vehicle 10 along the travel route between the used boarding and alighting area and the parking space is realized by autonomous traveling of the vehicle 10. In addition, in the automated valet parking service, the usage incentive information offering different treatments is provided for the usage of each of the boarding and alighting areas 6 so as to level the usage of the boarding and alighting areas 6. Hereinafter, specific processes of the automated valet parking service that are executed by the management system 100 will be described with reference to a flowchart.

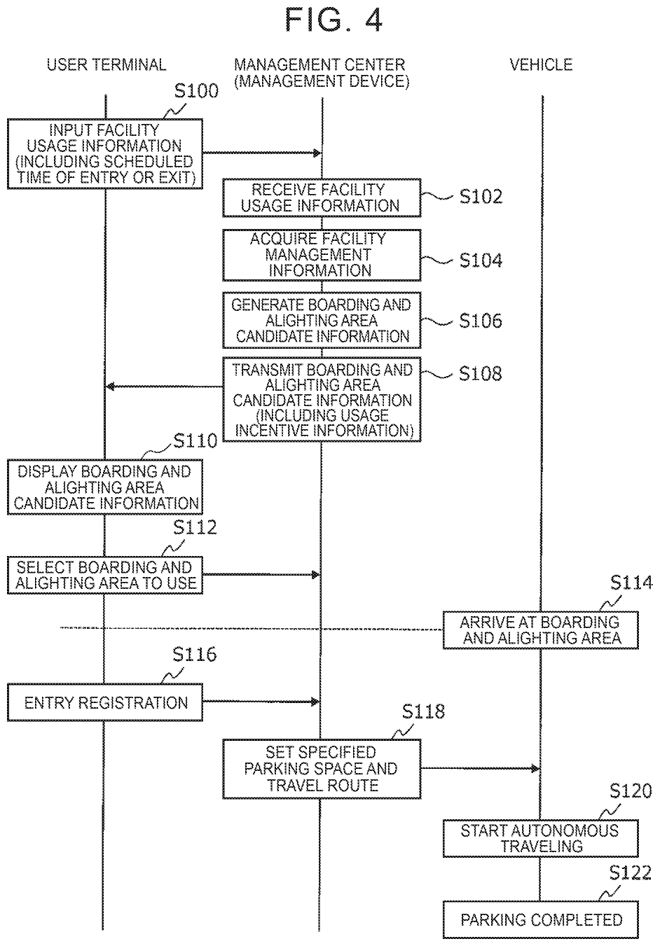

FIG. 4 is a flowchart illustrating a flow of the automated valet parking service provided by the management system. First, in step S100 of the flowchart shown in FIG. 4, facility usage information including the scheduled time of entry or exit of the vehicle 10 is input by the user through the user terminal 30. The input facility usage information is transmitted to the management center 20.

In step S102, the management center 20 receives the facility usage information through the reception unit 220 of the management device 22. In the next step S104, the management center 20 acquires the facility management information based on the received facility usage information. Here, the acquisition unit 222 of the management device 22 acquires the facility management information at the scheduled time of entry or exit included in the facility usage information.

In step S106, the boarding and alighting area candidate information is generated based on the acquired facility management information. The memory of the management device 22 stores content of various usage incentives as well as basic information such as position information of each boarding and alighting area. The generation unit 224 of the management device 22 provides more favorable usage incentive information for the boarding and alighting area having a low degree of congestion than for the boarding and alighting area having a high degree of congestion.

In step S108, the management center 20 transmits the generated boarding and alighting area candidate information to the user terminal 30.

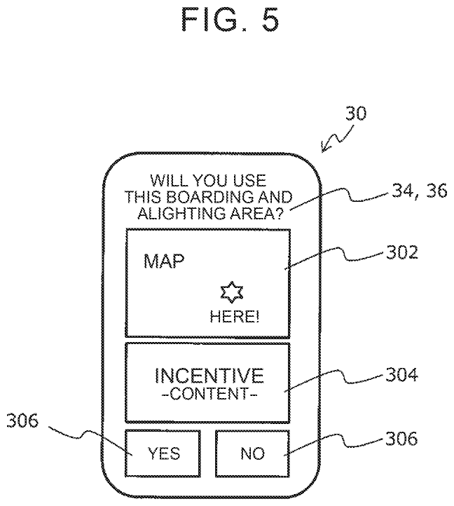

In step S110, the user terminal 30 displays the received boarding and alighting area candidate information on the display device 34. FIG. 5 is a diagram showing an example of the boarding and alighting area candidate information displayed on the user terminal. The user terminal 30 shown in FIG. 5 has a touch panel display having the functions of the input device 32 and the display device 34. In the example shown in FIG. 5, the display device 34 displays a usage incentive indication 304 provided for the boarding and alighting area candidate, in addition to a position information indication 302 of the boarding and alighting area candidate. Further, when there is a plurality of usage incentive candidates for the boarding and alighting area candidate, another usage incentive candidate may be displayed by swiping the touch panel display.

The display device 34 displays input indications 306 for inputting whether to use the displayed boarding and alighting area candidate. In the example shown in FIG. 5, options of “YES” and “NO” regarding using the displayed boarding and alighting area candidate are displayed. In step S112, when the user touches “NO” of the input indications 306, the position information indication 302 and the usage incentive indication 304 for another boarding and alighting area candidate are displayed. On the other hand, when the user touches “YES” of the input indications 306, the displayed boarding and alighting area candidate is selected as the used boarding and alighting area, and the information is transmitted to the management center 20.

In step S114, when the vehicle 10 arrives at the used boarding and alighting area, the user gets off the vehicle 10. In the next step S116, the user inputs the entry registration through the user terminal 30. The input entry registration is transmitted from the user terminal 30 to the management center 20.

In step S118, the management center 20 sets a parking space for the vehicle 10 and a travel route from the current position to the parking space. The set parking space and travel route are transmitted to the vehicle 10.

In step S120, the vehicle control device 12 of the vehicle 10 uses the autonomous traveling function of the related technology to perform autonomous traveling of the vehicle 10 along the set travel route. When the parking of the vehicle 10 in the parking space is completed in step S122, the parking processes of the automated valet parking service end.

According to the management method for the automated valet parking service by the management system 100 configured as described above, the usage incentive is provided for the usage of the boarding and alighting area, so that it is possible to prompt the user to use the boarding and alighting area having a lower degree of congestion. This makes it possible to alleviate local congestion at a specific boarding and alighting area and shorten the waiting time for the user.

In the management system 100 of the present embodiment, the management device 22 executes the process of step S102, so that a “reception step” that is an example of the disclosure is realized. The management device 22 executes the process of step S104, so that an “acquisition step” that is an example of the disclosure is realized. The management device 22 executes the process of step S106, so that a “generation step” that is an example of the disclosure is realized. The management device 22 executes the process of step S108, so that a “transmission step” that is an example of the disclosure is realized. The user terminal 30 executes the process of step S110, so that a “display step” that is an example of the disclosure is realized.

### 1-5. Modification

The management system 100 according to the first embodiment may employ the following modified modes.

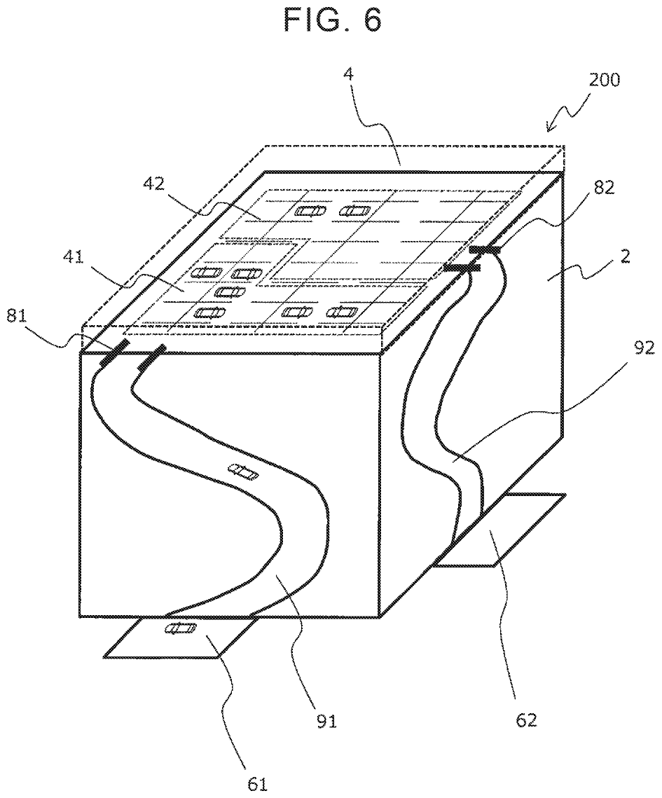

The parking facility 200 to which the management system 100 according to the present embodiment is applied is not limited in the number, shape, and layout of the boarding and alighting areas as long as the parking facility 200 provides the automated valet parking service and include the boarding and alighting areas 6. FIG. 6 is a schematic diagram illustrating another example of the parking facility managed by the management system of the present embodiment. In the parking facility 200 illustrated in FIG. 6, the parking lot 4 is provided on the top floor of the commercial facility 2 that is a building. The first boarding and alighting area 61 and the second boarding and alighting area 62 that serve as the boarding and alighting areas for users in the automated valet parking are provided on the ground floor (first floor). A first slope 91 and a second slope 92 are provided, on which vehicles travel from the first boarding and alighting area 61 and the second boarding and alighting area 62, respectively, to the parking lot 4. In such a parking facility 200, the management system 100 of the present embodiment can be applied. It should be noted that this modification can also be applied to the management systems of other embodiments described later.

The management center 20 may be constituted by a vehicle management center that mainly performs reservation management, vehicle management, etc. of the automated valet parking service and a parking lot management center that mainly performs parking lot management of the automated valet parking service. In this case, the vehicle management center and the parking lot management center are configured to be able to communicate with each other via the network 110. The functions of the management center 20 are separated to be located in the vehicle management center and the parking lot management center. There is no limitation on the location of functions of the management center 20. For example, of the functions of the management center 20, the functions of the reception unit 220, the acquisition unit 222, the generation unit 224, and the transmission unit 226 are typically located in the vehicle management center. For example, of the functions of the management center 20, the function of the travel route setting unit 228 is located in the parking lot management center. It should be noted that this modification can also be applied to the management systems of other embodiments described later.

### 2. Second Embodiment

Next, a management system according to a second embodiment will be described with reference to the drawings.

### 2-1. Configuration of Management System According to Second Embodiment

The configuration of the management system according to the second embodiment is the same as that of the management system 100 according to the first embodiment shown in FIG. 1. Therefore, detailed description of the configuration of the management system according to the second embodiment will be omitted.

### 2-2. Characteristic Functions of Management System According to Second Embodiment

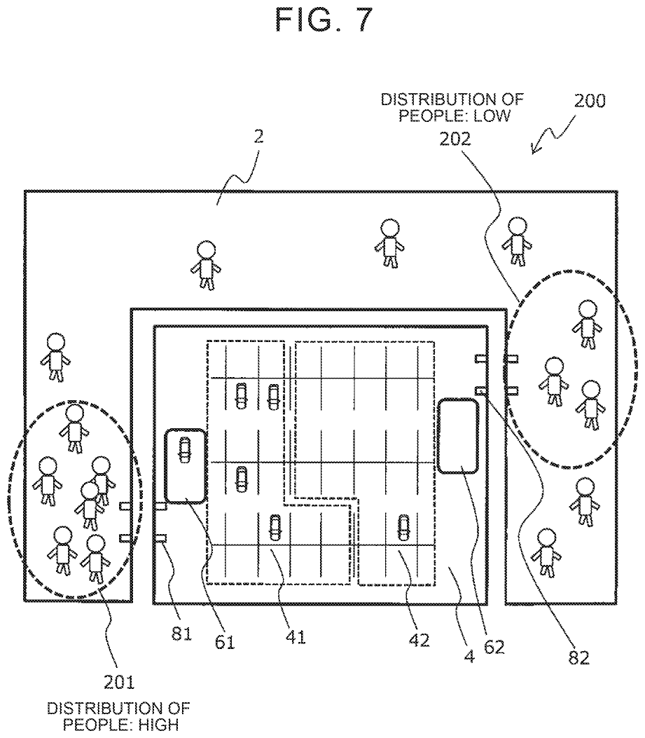

The management system 100 according to the present embodiment is characterized in that the distribution of people in the commercial facility 2 attached to the parking lot 4 is used as the facility management information. FIG. 7 is a diagram schematically showing the distribution of people in the commercial facility. For example, a case is considered where in the commercial facility 2, the density of people in a first area 201 around the first entrance 81 is higher than the density of people in a second area 202 around the second entrance 82, as shown in FIG. 7. In order to ensure a smooth flow of people in the commercial facility 2, it is preferable to level the distribution of people in the commercial facility 2 as much as possible. However, for example, if the automated valet parking service using the first boarding and alighting area 61 is performed in the case of the distribution of people shown in FIG. 7, congestion of people will further increase around the first area 201.

Therefore, the management system 100 according to the present embodiment acquires, as the facility management information, information indicating the distribution of people in the commercial facility 2 at the scheduled time of entry or exit of the vehicle 10. Examples of such facility management information include the number, the density, etc. of people in each of the first area 201 and the second area 202 at the scheduled time of entry or exit. In the commercial facility 2, a plurality of motion sensors and surveillance cameras are installed. The acquisition unit 222 of the management device 22 analyzes past data obtained from the sensors and the cameras and sorted by time, so as to acquire the facility management information at the scheduled time of entry or exit. The acquired facility management information is stored in the memory of the management device 22.

The generation unit 224 generates the boarding and alighting area candidate information based on the facility management information. The management device 22 stores various usage incentives and basic information such as position information of the boarding and alighting areas 6 in the memory. Based on the facility management information, the generation unit 224 generates the boarding and alighting area candidate information in which the usage incentive information is provided for information of each candidate of the boarding and alighting areas 6. Typically, the generation unit 224 provides more favorable usage incentive information for the second boarding and alighting area 62 corresponding to the second area 202 than for the first boarding and alighting area 61 corresponding to the first area 201. The second area 202 has a lower distribution of people than the first area 201. The generated boarding and alighting area candidate information is stored in the memory of the management device 22. The transmission unit 226 reads out the boarding and alighting area candidate information stored in the memory and transmits the boarding and alighting area candidate information to the user terminal 30 associated with the vehicle 10.

According to the parking processes executed by such an automated valet parking service, it is possible to prompt the users to use the second boarding and alighting area 62 corresponding to the second area 202 having a lower distribution of people in the commercial facility 2. Thus, it is possible to level the distribution of people in the commercial facility 2.

What is claimed is:

1. A management device configured to manage automated valet parking in which, in a parking facility having a plurality of boarding and alighting areas, entry of a vehicle from a used boarding and alighting area selected from the boarding and alighting areas to a parking space of the parking facilities or exit of the vehicle from the parking space to the used boarding and alighting area is performed through autonomous traveling of the vehicle, the management device comprising:
a reception unit configured to receive facility usage information including a scheduled time of entry or exit of the vehicle by the automated valet parking;
an acquisition unit configured to acquire facility management information indicating a congestion status of the parking facility at the scheduled time of entry or exit, based on the facility usage information;
a generation unit configured to generate boarding and alighting area candidate information in which usage incentive information corresponding to the congestion status is provided for each of candidates of the boarding and alighting areas, based on the facility management information; and
a transmission unit configured to transmit the boarding and alighting area candidate information to a terminal device associated with the vehicle.

2. The management device according to claim 1, wherein:
the facility management information is information indicating a degree of congestion of each of the boarding and alighting areas at the scheduled time of entry or exit; and
the generation unit is configured to provide more favorable usage incentive information for a second boarding and alighting area than for a first boarding and alighting area, the second boarding and alighting area having a lower degree of congestion than the first boarding and alighting area.

3. The management device according to claim 1, wherein:
the parking facility includes a plurality of parking areas respectively corresponding to the boarding and alighting areas;
the facility management information is information regarding a distribution of parked vehicles in each of the parking areas at the scheduled time of entry or exit; and
the generation unit is configured to provide more favorable usage incentive information for a second boarding and alighting area corresponding to a second parking area than for a first boarding and alighting area corresponding to a first parking area, the second parking area having a lower distribution of parked vehicles than the first parking area.

4. The management device according to claim 1, wherein:
the parking facility includes a commercial facility attached to the parking facility;
the facility management information is information regarding a distribution of people in the commercial facility at the scheduled time of entry or exit; and
the generation unit is configured to provide more favorable usage incentive information for a second boarding and alighting area corresponding to a second area than for a first boarding and alighting area corresponding to a first area, the second area having a lower distribution of people than the first area.

5. The management device according to claim 1, wherein the usage incentive information includes a proposal of reducing a usage fee related to the automated valet parking.

6. A management system for automated valet parking, the management system comprising:
a management device configured to manage automated valet parking in which, in a parking facility having a plurality of boarding and alighting areas, entry of a vehicle from a used boarding and alighting area selected from the boarding and alighting areas to a parking space of the parking facility or exit of the vehicle from the parking space to the used boarding and alighting area is performed through autonomous traveling of the vehicle; and
a terminal device associated with the vehicle configured to perform the automated valet parking, wherein:
the terminal device includes an input device and a display device;
the terminal device is configured to input, through the input device, facility usage information including a scheduled time of entry or exit of the vehicle by the automated valet parking, and configured to transmit the facility usage information to the management device;
the management device includes
a reception unit configured to receive the facility usage information,
an acquisition unit configured to acquire facility management information indicating a congestion status of the parking facility at the scheduled time of entry or exit based on the facility usage information,
a generation unit configured to generate boarding and alighting area candidate information in which usage incentive information corresponding to the congestion status is provided for each of candidates of the boarding and alighting areas, based on the facility management information, and
a transmission unit configured to transmit the boarding and alighting area candidate information to the terminal device associated with the vehicle; and
the terminal device is configured to display the received boarding and alighting area candidate information on the display device.

7. The management system according to claim 6, wherein:
the facility management information is information indicating a degree of congestion of each of the boarding and alighting areas at the scheduled time of entry or exit; and
the generation unit is configured to provide more favorable usage incentive information for a second boarding and alighting area than for a first boarding and alighting area, the second boarding and alighting area having a lower degree of congestion than the first boarding and alighting area.

8. The management system according to claim 6, wherein:
the parking facility includes a plurality of parking areas respectively corresponding to the boarding and alighting areas;
the facility management information is information regarding a distribution of parked vehicles in each of the parking areas at the scheduled time of entry or exit; and
the generation unit is configured to provide more favorable usage incentive information for a second boarding and alighting area corresponding to a second parking area than for a first boarding and alighting area corresponding to a first parking area, the second parking area having a lower distribution of parked vehicles than the first parking area.

9. The management system according to claim 6, wherein:
the parking facility includes a commercial facility attached to the parking facility;
the facility management information is information regarding a distribution of people in the commercial facility at the scheduled time of entry or exit; and
the generation unit is configured to provide more favorable usage incentive information for a second boarding and alighting area corresponding to a second area than for a first boarding and alighting area corresponding to a first area, the second area having a lower distribution of people than the first area.

10. The management system according to claim 6, wherein the usage incentive information includes a proposal of reducing a usage fee related to the automated valet parking.

11. A method for managing automated valet parking in which, in a parking facility having a plurality of boarding and alighting areas, entry of a vehicle from a used boarding and alighting area selected from the boarding and alighting areas to a parking space of the parking facility or exit of the vehicle from the parking space to the used boarding and alighting area is performed through autonomous traveling of the vehicle, the method comprising:
a reception step of receiving facility usage information including a scheduled time of entry or exit of the vehicle by the automated valet parking;
an acquisition step of acquiring facility management information indicating a congestion status of the parking facility at the scheduled time of entry or exit, based on the facility usage information;
a generation step of generating boarding and alighting area candidate information in which usage incentive information corresponding to the congestion status is provided for each of candidates of the boarding and alighting areas, based on the facility management information; and
a display step of displaying the boarding and alighting area candidate information on a display device of a terminal device associated with the vehicle.
